(19) United States
(12) Patent Application Publication
(10) Pub. No.: US 2011/0270774 A1
(43) Pub. Date: Nov. 3, 2011

(54) Group Recommendations in Social Networks

(75) Inventors: Roy Varshavsky, Tel Aviv (IL); Moshe Tennenholtz, Haifa (IL); Yuval Peres, Redmond, WA (US); David B. Wilson, Redmond, WA (US)

(73) Assignee: Microsoft Corporation, Redmond, WA (US)

(21) Appl. No.: 12/772,083

(22) Filed: Apr. 30, 2010

(51) Int. Cl. G06Q 30/00; G06Q 99/00

(52) U.S. Cl. 705/319; 705/347

(57) ABSTRACT

Providing a recommendation to a group of networked members is disclosed. The recommendation is provided to the group collectively, and is based on trust relationships between the members of the network. In an example embodiment, the network is a social network. Example systems and methods include a two-phase approach and a one-phase approach, each including analysis and aggregation of input associated with members of the network.

### CROSS REFERENCE TO RELATED APPLICATIONS

This application is related to U.S. Patent Application Publication No. 2009/0314989 entitled “Trust-Based Recommendation Systems” filed on Apr. 28, 2008, and U.S. patent application Ser. No. 12/500657 entitled “Hybrid Recommendation Systems” filed Jul. 2009, the entirety of both are incorporated herein by reference.

### BACKGROUND

Emergence of global communication networks such as the Internet and major cellular networks has precipitated interaction between users and other network entities. Today, cellular and IP networks are a principal form of communications and a central medium for interacting with other users for a variety of purposes. Network users now have mechanisms for searching and communicating (or socializing) on virtually any topic of interest.

One such network entity that provides social interaction around common subjects is a social network. In general, social network theory may focus on the relationships and links between individuals or groups of individuals within the network, rather than attributes of individuals or entities. A social network typically consists of links between individuals through which social information/opportunities are exchanged, and relationships are developed. Such a “trust relationship” may imply that two people “know” each other and typically have a certain amount of trust for each other.

For example, a person may be searching for a job and contact friends to determine if they are aware of available job positions. Such friends may be able to provide reliable information about positions that they know about. Additionally, such friends could be a reference for their job-seeking friend to a potential employer. Furthermore, relationships may be employed to obtain social information and/or opportunities, such as, for example, information about possible romantic partners, movies, restaurants, buying or selling merchandise, recommendations for leisure or professional activities, and the like.

Moreover, trust relationships can further facilitate obtaining accurate information and opportunities because of the associated reliability of information and individuals being involved. For example, an individual may be more willing to swap a vacation home with a friend of a friend than to house swap with a stranger. A basis for such trust is that the immediate friend can be trusted to offer an honest assessment of the trustworthiness of the third party. Accordingly, social networks can often be relied upon for opinion based information, such as to obtain opinions about activities participated in by other users. Such information may be relied on more often than an opinion of an individual expert such as a famous restaurant or movie critic.

However, when a recommendation regarding a particular interest is desired, a social network may be difficult to quickly employ to provide a recommendation on that subject. This may be particularly so when the recommendation is sought for a group of individuals.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

This application describes techniques for providing a group recommendation to a group of users collectively. In one embodiment, a system may be implemented on a computer, and may include an analysis component configured to produce a plurality of individual recommendations for an item (e.g., product, service, venue, etc.). The recommendation may be produced based on trust relationships between members of the group of users and/or members of the social network that are not members of the group of users. The system may also include an aggregation component configured to aggregate the plurality of individual recommendations to produce the group recommendation.

In another implementation, a computer implemented method is disclosed for providing a recommendation to a group of users collectively, where the group of users comprises a subset of a social network. The method includes designating trust relationships between the members of the social network. The method further includes collecting input (e.g., votes, opinions, etc.) from the members of the social network that may or may not be in the group regarding an item and analyzing the input in conjunction with the designated trust relationships to produce individual recommendations. The method further includes aggregating the individual recommendations to produce an aggregated recommendation and outputting the aggregated recommendation to the group.

In a further implementation, a computer implemented method is disclosed for providing a recommendation to a group of users collectively, where the group of users is a subset of a social network. The method includes designating trust relationships between the members of the social network. The method further includes collecting input (e.g., votes, opinions, etc.) from members of the social network that may or may not be in the subset regarding an item (e.g., product, service, venue, etc.), analyzing the input in conjunction with the designated trust relationships, and aggregating the input based on the analysis and an aggregation algorithm, where the aggregation is also based on the designated trust relationships. The method further includes producing a group recommendation based on the analysis and the aggregation and outputting the group recommendation to the subset.

### BRIEF DESCRIPTION OF THE DRAWINGS

The Detailed Description is set forth with reference to the accompanying figures. In the figures, the left-most digit(s) of a reference number identifies the figure in which the reference number first appears. The use of the same reference numbers in different figures indicates similar or identical items.

FIG. 1 illustrates a block diagram of a recommendation system that produces a group recommendation, according to an example embodiment.

FIG. 2 illustrates a block diagram of a two-phase recommendation system that produces a group recommendation, according to an example embodiment.

FIG. 3 illustrates a block diagram of an implementation of an individual trust-based recommendation algorithm that employs an analysis component, according to an example embodiment.

FIG. 4 illustrates a block diagram of a one-phase recommendation system that produces a group recommendation, according to an example embodiment.

FIG. 5 illustrates a block diagram of an implementation of an aggregated recommendation algorithm that employs an analysis component, according to an example embodiment.

FIG. 6 illustrates a block diagram of an example computer-implemented process, using an analysis component, which facilitates aggregation of opinions of users in a trusted social network, according to an example embodiment.

FIG. 7 illustrates an example two-phase methodology of providing a group recommendation for an item in a trusted network, according to an example embodiment.

FIG. 8 illustrates an example one-phase methodology of providing a group recommendation for an item in a trusted network, according to an example embodiment.

FIG. 9 illustrates an exemplary environment for implementing various embodiments of group recommendation in social networks.

FIG. 10 is a schematic block diagram of a sample computing environment that can be employed for a recommendation system according to an example embodiment.

### DETAILED DESCRIPTION

This disclosure describes various techniques for providing a recommendation to a group of networked members. In one embodiment, the members of the group are networked within a social network and the recommendation is provided to the group collectively. Generally, providing a recommendation to a group leverages relationships, for example, trust relationships, between the networked members. The application describes a two-phase approach, which includes aggregating the results of individual recommendations produced for each of the members of the group. The application also describes a single-phase approach, which includes producing a single recommendation based on an aggregate of the group preferences.

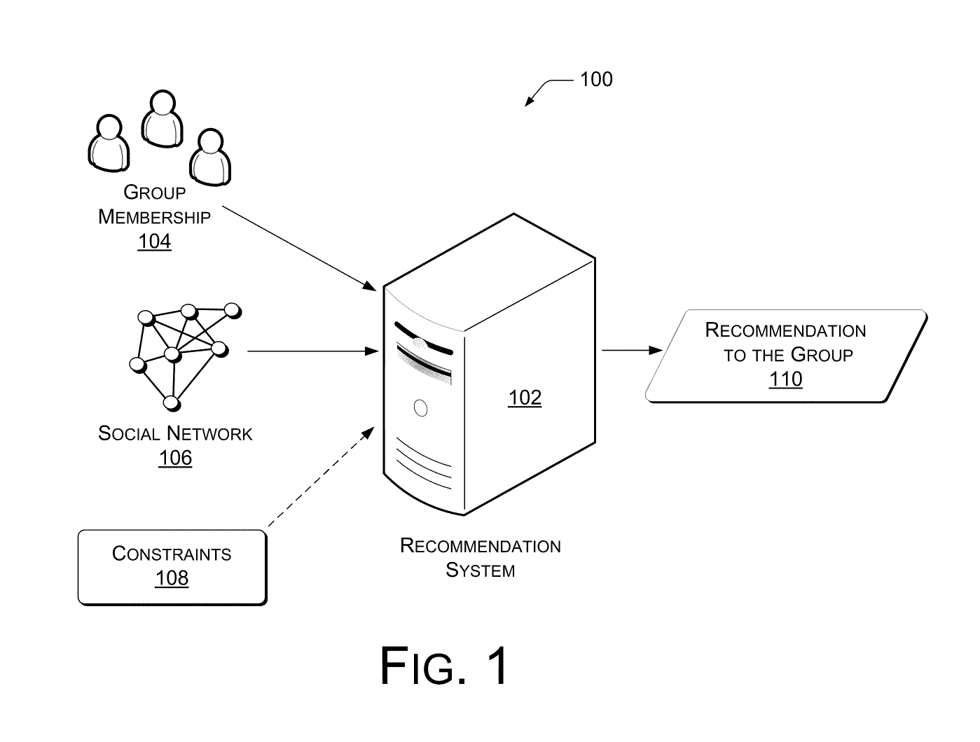

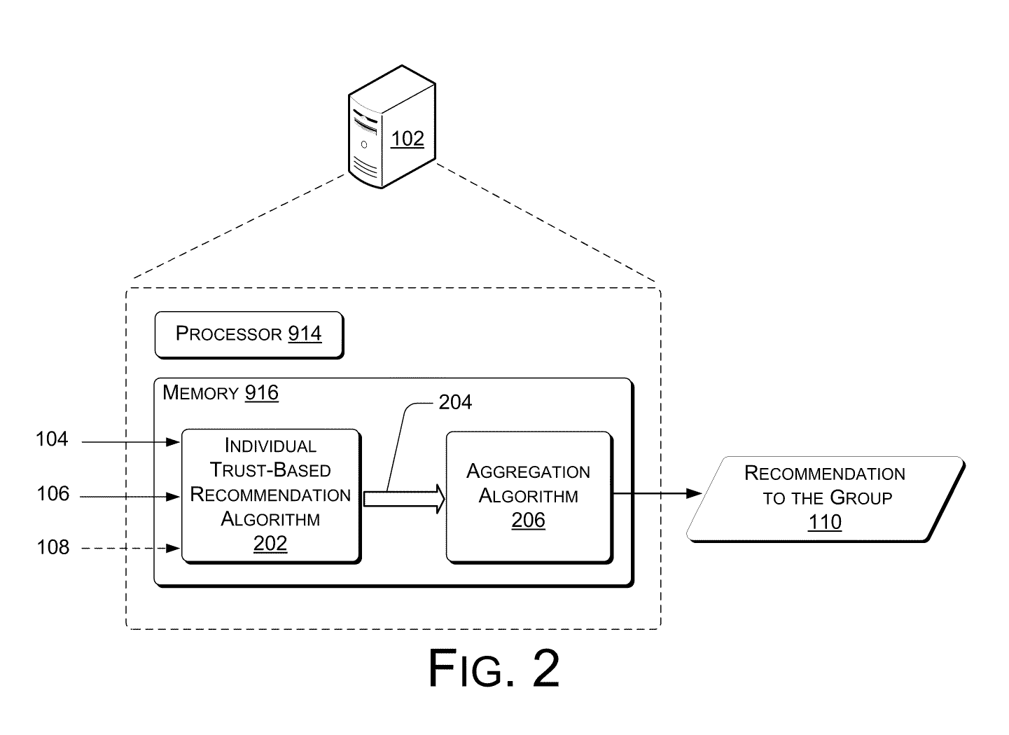

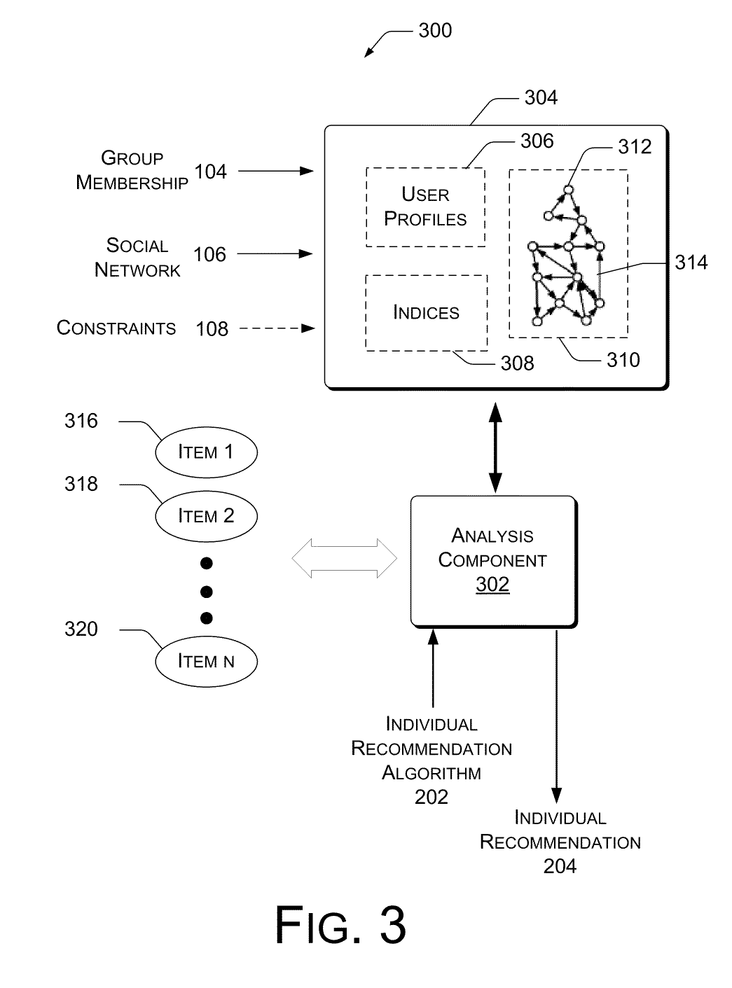

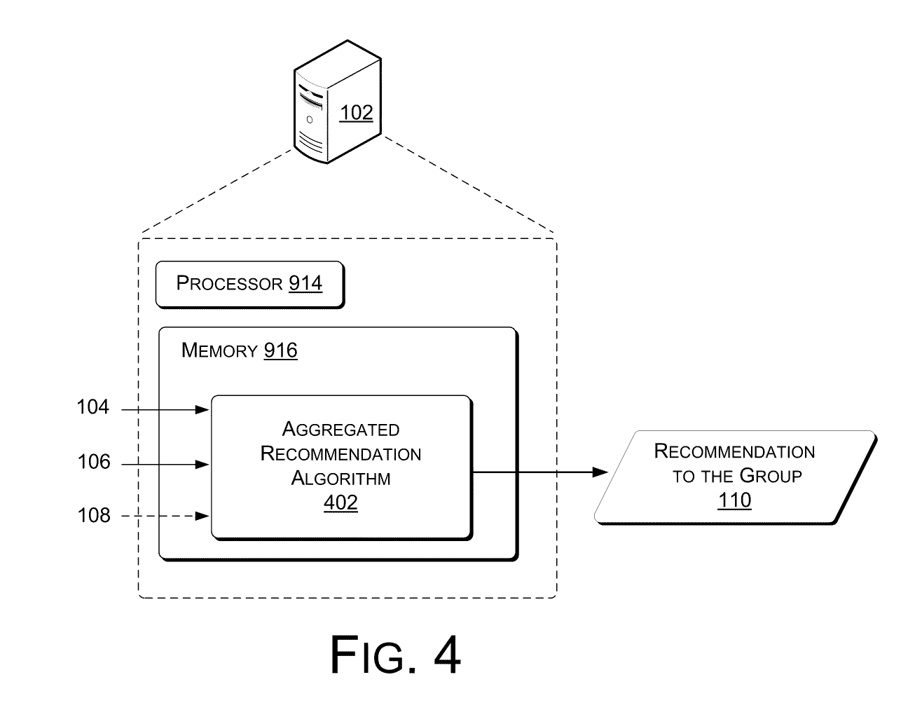

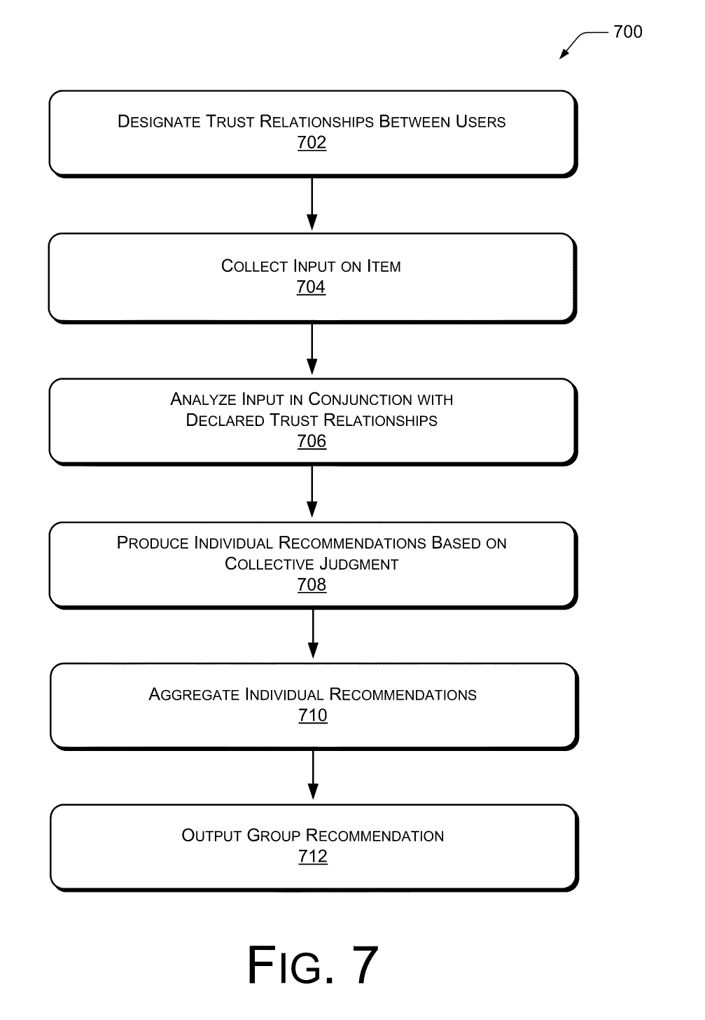

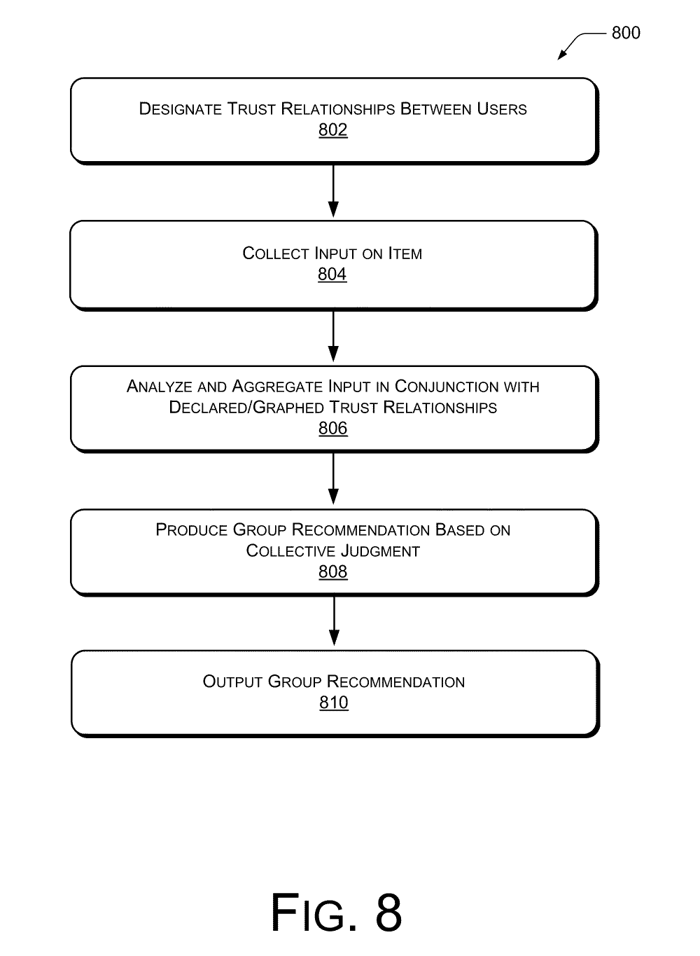

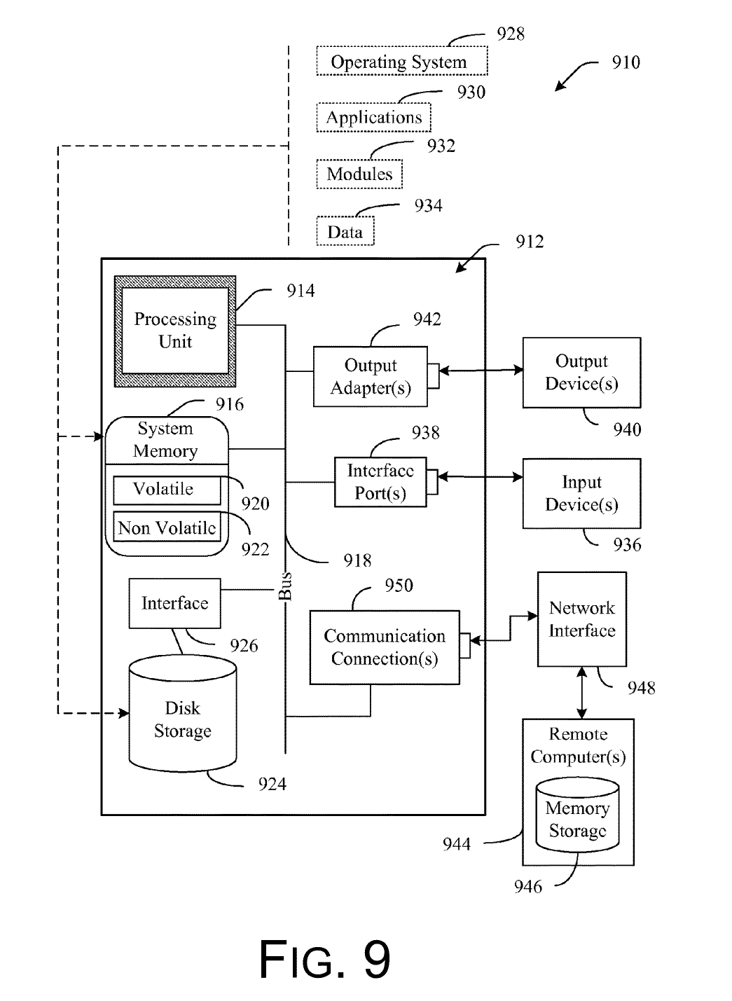

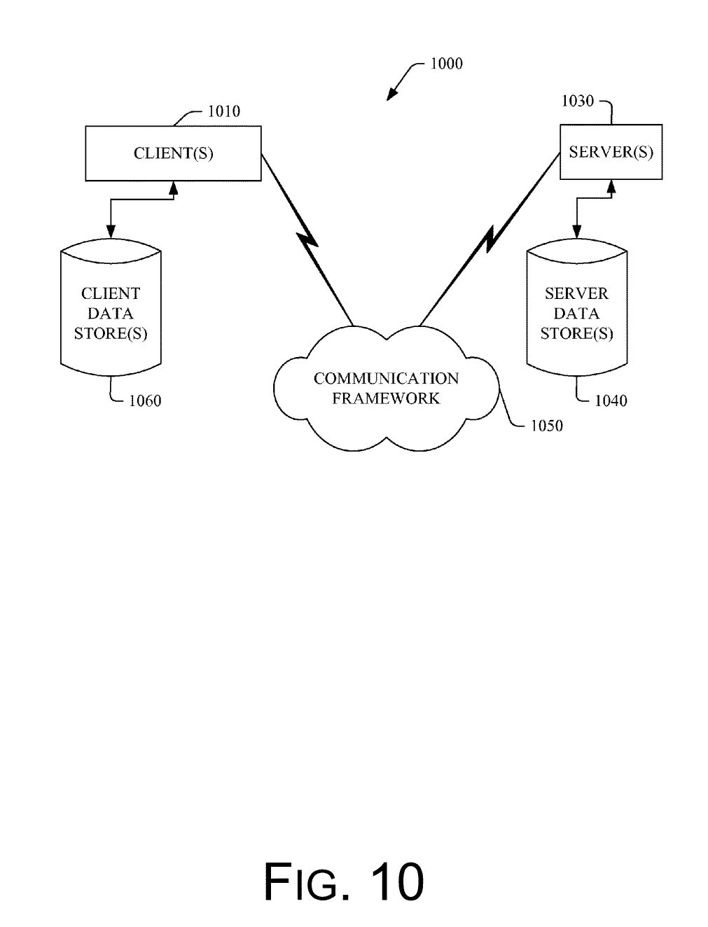

Systems and methods for providing a recommendation to a group are disclosed as follows. An overview of a system or method of providing a recommendation is given with reference to FIG. 1. Discussion of a two-phase approach with example embodiments is given with reference to FIGS. 2 and 3. Discussion of a one-phase approach with example embodiments is given with reference to FIGS. 4-6. Example methods for providing a recommendation to a group are discussed with reference to FIGS. 7 and 8. Example architectures for implementing the systems and methods are described with reference to FIGS. 9 and 10, the example architectures including example computing environments and associated computer hardware.

### OVERVIEW

In general, the opinions of users regarding an item (e.g., a product or service, etc.) may be considered in combination to provide a recommendation related to the item, particularly when the users are members of a trusted network. FIG. 1 is a block diagram of an example recommendation system 102 illustrating a general group recommendation scenario. In one embodiment, the recommendation system 102 is a trust-based recommendation system that exploits an explicit social network, including trust relationships present between members of the social network, in order to provide a recommendation. In the example illustration, inputs to the recommendation system 102 include group membership 104, a social network 106, and constraints 108 (if any). In alternate embodiments, fewer or additional inputs may be included (e.g., feedback received, status within the social network, etc.).

Since the example recommendation system 102 leverages trust relationships between members of a networked group, membership in the group (group membership 104) and a social network 106 are included as inputs. In one embodiment, group membership 104 may comprise a casual affiliation of persons with at least one commonality. For example, group membership 104 may comprise a number of persons who have decided to go to a concert together, or have dinner together, and the like. In alternate embodiments, group membership may comprise alternate or additional components. For example, in one embodiment, group membership 104 may include registration with the social network 106, subscription to a defined group or sub-group within a social network, membership in an organization, or the like. In one embodiment, group membership 104 implies trust relationships with one or more other members of the group, or with members of the social network 106.

The social network 106 (trusted network) may include any of various social networks (e.g., Facebook®, LinkedIn®, MySpace.com™, etc.) generally accessed via the Internet or a similar network. In alternate embodiments, the social network 106 may include other networks that have physical and/or virtual components (e.g., organizations, memberships, email contact lists, instant messaging (IM) contacts, etc.).

In some embodiments, one or more constraints 108 may be included as inputs to the recommendation system 102. In alternate embodiments, no constraints 108 are included. Constraints 108 may include imperatives relative to the sought-after recommendation, such as a common interest in the recommendation, logistical issues, and the like. For example, all of the members of a group may want to attend the same concert together, or go to the same restaurant together.

The output of the recommendation system 102 is a recommendation 110 provided to the group of networked members, based on the opinions of a subset of the social network 106. In alternate embodiments, the subset of the social network 106 may include various other members of the social network that may or may not be a member of the group. In various embodiments, the recommendation 110 may be in the form of a prioritized list, a general or detailed analysis, and the like.

In one embodiment, the output of the recommendation system 102 is displayed on a display device. In alternate embodiments, the display device may be any device for displaying a recommendation to a user (e.g., computer monitor, mobile communications device, personal digital assistant (PDA), electronic pad or tablet computing device, projection device, imaging device, and the like). For example, the recommendation 110 may be displayed on a user's mobile telephone display. In alternate embodiments, the output may be provided to the user by another method (e.g., email, posting to a website, posting on a social network page, text message, etc.).

### Example Two-Phase Approach

In one embodiment, as illustrated in FIG. 2, a recommendation 110 may be provided to members of a group by aggregating the results of individual recommendations produced for each of the members of the group. For example, an individual trust-based recommendation algorithm 202 may be used to provide an individual recommendation 204 to each of the members of the group. An aggregation algorithm 206 may then be employed using individual recommendations 204 and produce a group recommendation 110.

For example, a group of friends (who, in this example, are all members of a social network 106) may desire a recommendation for a restaurant. Using the example embodiment above, an individual trust-based recommendation algorithm 202 may be used to provide an individual restaurant recommendation 204 to each of the friends. In alternate embodiments, the recommendation 204 may be derived based on trust-relationships between the individual friends and other members of the social network 106. An aggregation algorithm 206 is then used to combine the individual restaurant recommendations 204 to produce a single restaurant recommendation 110 for the group of friends collectively. In alternate embodiments, various aggregation algorithms 206 may be used (e.g., voting, averaging, minimum or maximum, etc.) to produce the recommendation 110.

### Example Trust-Based Recommendation System

FIG. 3 illustrates a block diagram of an example individual trust-based recommendation system 300 that analyzes aggregate opinions of users regarding an item (e.g., a product or service, etc.) using an individual trust-based recommendation algorithm 202. The output of the system 300 is an individual recommendation 204. The system 300 makes use of a trusted network 106, to suggest a recommendation 204 related to the item by employing an analysis component 302.

A computer implemented system implementing the individual trust-based recommendation system 300 can include a storage (memory) 304 that stores a variety of data such as for example, user/entity profiles 306 (which may include information regarding group membership 104, social network 106, and/or constraints 108), indices 308, and a graph 310 of the social network 106. The user profiles 306 can contain attributes of individuals or entities (e.g., declared trust relationships) associated with the social network 106, in accordance with an embodiment. The respective user profiles 306 can vary as to quantity as well as quality and type of attribute information, and the trust relationships among user/nodes (e.g., which user/nodes trusts which user nodes). For example, such profile information can be directly supplied via each user or node associated with the social network 106. It is to be appreciated that any of a variety of information gathering schemes and sub-schemes (e.g., data mining, cookies, data scavenging, 3rd party provider, and the like) can also be employed in connection with collection of such attributes for the indices 308 and user profiles 306.

The graph 310 associated with the social network 106 can represent a collection of information relating to users (e.g. individuals) and relationships there between. In one embodiment, the graph 310 includes nodes 312 representing members of a social network 106 and arcs (or edges) 314 representing levels of trust between the members. In alternate embodiments, the edges 314 may represent one-way or two-way trust relationships. Additionally or alternatively, the edges 314 may represent the strength of a trust relationship, the weighted value of the trust relationship, a mutual trust relationship, or the like.

The graph 310, although pictorially depicted in FIG. 3 as a graph of vertices and arcs, can take many data-structure type forms (e.g., table, relational databases, XML based databases, and the like), and functionally represents intra-relationships between subsets of individuals and/or entities within the social network 106.

The nodes 312 of the graph 310 can further represent devices that are part of a network (e.g., wired or wireless network) such as a system area network or other type of network, and can include several hosts, (not shown), which can be personal computers, servers or other types of computers. Such hosts generally can be capable of running or executing one or more application-level (or user-level) programs, as well as initiating an I/O request (e.g., I/O reads or writes). In addition, the network can be, for example, an Ethernet LAN, a token ring LAN, or other LAN, a Wide Area Network (WAN), or the like. Moreover, such network can also include hardwired and/or optical and/or wireless connection paths.

In addition, connections can be shared among the users/nodes of the social network 106, wherein participants can further employ devices (e.g., personal computers, workstations, televisions, telephones, and the like) for example. The example networks can include a plurality of input/output units (I/O units), wherein such I/O units can include one or more I/O controllers connected thereto, and each of the I/O units can be any of several types of I/O devices, such as storage devices (e.g., a hard disk drive, tape drive) or other I/O device. The hosts and I/O units and their attached I/O controllers and devices can be organized into groups such as clusters and sub social networks, with each cluster including one or more hosts and typically one or more I/O units (each I/O unit including one or more I/0 controllers). The hosts and I/O units can be interconnected via a collection of routers, switches and communication links (such as wires, connectors, cables, and the like) that connects a set of nodes (e.g., connects a set of hosts and I/O units) of one or more clusters. It is to be appreciated that a wireless communication network can be cellular or WLAN communication network; such as Global System for Mobile communication (GSM) networks, Universal Mobile Telecommunication System (UMTS) networks, wireless Internet Protocol (IP) networks such as Voice over Internet Protocol (VoIP) and IP Data networks, and the like.

In one embodiment, an individual trust-based recommendation system 300 may employ an analysis component 302. Such analysis component 302 can output an individual evaluation and/or recommendation 204 for an item based on the trust relationship(s) declared by users (e.g., which other users/nodes are trusted by this user), and the voting behavior in the trusted network.

The analysis component 302 can supply a recommendation 204 associated with each user, based on the trust relationship indicated by such user (e.g., which other users/nodes are trusted by this user), and the input (e.g., votes, opinions, etc.) supplied by such other users/nodes. Accordingly, within the graph 310 and the linked structure of nodes 312, personalized recommendations 204 associated to users (e.g., agents) can be supplied about an item (or items) 316, 318, 320 (1 thru n, n being an integer). Such recommendations 204 can be based upon the opinions and reviews of other users, as well as declared trust between the users. Hence, in one example, the recommendation system 300 leverages characteristics of a user, to determine a personalized recommendation for such user based on the input of nodes in the trust network around this user, and further aggregate the input (votes, opinions, etc.) of users to a single recommendation.

It is to be understood for the purposes of this disclosure that the use of the terms “vote,” “opinion,” and the like is for ease of understanding, and that such use is not limiting, but encompasses all forms of user input regarding an item. For example, input may include direct or indirect voting, surveys, polling, previous purchase histories, web browsing activities, preferences, comments, ratings, reviews, criticisms, analyses, evaluations, cookies, and the like. Accordingly, in alternate embodiments, input may be solicited from users, input may be derived implicitly from user behavior/history, input may be directly or indirectly supplied by user initiative, and/or combinations thereof.

The items 316, 318, 320 may include files, such as photographs, word processing files, spreadsheets, and the like, as well as web pages, emails, retail shopping catalogue/products and any other suitable types of items for which an opinion of users can be collected. For example, the items 316, 318, 320 may be restaurants that a group is considering for dinner or concerts that the group is considering attending. Such items 316, 318, 320 can further include items of a substantially similar type or items of disparate types, and can be restricted based upon desired implementation. For example, the items 316, 318, 320 can reside within a computer, be associated with a hard drive, a removable storage media, an application(s), and the like. Moreover, the items 316, 318, 320 can also be related to the Internet or an intranet and merchandise related therewith.

As such, within a linked structure of nodes 312, personalized recommendations 204 to users (e.g., agents) are supplied about an item(s) based upon the opinions/reviews of other users, and in conjunction with the declared trust there between. Thus, in alternate embodiments, the system 300 leverages characteristics of a user, to determine a personalized recommendation 204 for such user based on the input of nodes 312 in the trust network associated with this user, and further aggregates input (e.g., votes, opinions, etc.) of users, into a single recommendation 204.

According to an alternate embodiment, the system 300 can implement an axiomatic approach (e.g., specifying desired properties), wherein class of models can be defined. As such, a set of natural axioms are designated and a subset thereof can be satisfied simultaneously depending upon characteristics of the recommendation system involved, as described in detail infra. The analysis component 302 of the recommendation system 300 forms a collective opinion of the users by analyzing the input of such users, and relation of trust that is initially declared there between.

In one embodiment, each user can designate which other users it trusts, wherein such trust relation can be supplied to the analysis component 302. Subsequently, a user can opine on a product (item) via a voting process (e.g., casting a “yes” vote or a “no” “vote,” or a “neutral” vote). By accumulating such votes in conjunction with the already established trust relationship, the opinion of users who have formed judgment about a product (item) can be shared with another user(s) who has indicated trust in such users. In alternate embodiments, a user (trusted member of the social network) may vote using discrete values (e.g., yes, no, neutral, “+,” “−,” “0,” “1,” etc.), may express an opinion using a range of values (e.g., “from 0 to 5,” “from 1 to 10,” etc.) or the user may express an opinion using an analog scale (“any value from −1 to 1”). In further alternate embodiments, the user may express an opinion using descriptive language selected from offered choices (e.g., “excellent,” “good,” “neutral,” “poor,”) or through free form text entry, or the like.

Accordingly, for each given user (e.g., represented by a node 312 in the system), other nodes (e.g., other users) that are trusted in the social network 106 can be identified and their collective judgment employed to output a recommendation 204 and/or evaluation for the product. In a related aspect, machine learning systems (e.g., inference components) can employ probabilities to suggest inferred relationships among votes and trust relationships. Such machine learning systems can also be trained (implicitly as well as explicitly) based on a possible identified voting behavior, wherein recommendations 204 for items can be facilitated based on indexes/trends that are derived initially from the aggregate behavior (e.g., voting) of other users.

### Aggregation

Referring back to FIG. 2, the output of the individual trust-based recommendation algorithm 202 is an individual recommendation 204, or in other words, a recommendation intended for an individual. In one example embodiment, a computer implemented system implementing the recommendation system 102 implements an aggregation algorithm 206 by way of an aggregation component (not shown). In one embodiment, the aggregation component and/or the analysis component are stored in the storage 304 (shown in FIG. 3). In alternate embodiments, the aggregation component and/or the analysis component may be implemented in hardware, firmware, software, and the like, and may be stored in other locations accessible to the processing device (shown in FIG. 9). For example, in one embodiment, the aggregation component and the analysis component are the same component, performing the functions of analysis, recommendation, and aggregation.

The aggregation component may be configured to use the aggregation algorithm 206 to aggregate each of the resulting individual recommendations 204 that are output by the analysis component 302 (using the individual trust-based recommendation algorithm 202) into a single recommendation 110 for a group. The result of this aggregation is a recommendation 110 to the group that is based on recommendations 204 that were produced for individual members of the group.

For example, in the example above about friends going to a restaurant, an aggregation algorithm 206 may be used to combine individual restaurant recommendations 204 (produced for each of the individuals in the group) to produce a single restaurant recommendation 110 for the group of friends collectively.

In alternate embodiments, various aggregation algorithms may be used as the aggregation algorithm 206 to produce the recommendation 110. For example, the aggregation algorithm 206 may be based on the principles of indifference, maximin, minmax regret, competitive ratio decision criteria, voting, consensus, averages, minimum conservative approach, and the like.

### Example One-Phase Approach

FIG. 4 illustrates a block diagram of an example recommendation system 102 according to an embodiment implementing a one-phase approach. In one embodiment, the recommendation system 102 comprises an aggregated recommendation algorithm 402. The aggregated recommendation algorithm 402 receives as inputs the group membership 104, the social network 106, and in some embodiments, the constraints 108. The aggregated recommendation algorithm 402 outputs a recommendation to the group 110.

For example, the group of friends from the example above may use a one-phase approach to receive a recommendation for a restaurant. An aggregated recommendation algorithm 402 may be used to provide an aggregate group recommendation 110 to the friends collectively. In alternate embodiments, the recommendation 110 may be derived based on trust-relationships between the individual friends and other members of the social network 106. For example, the aggregated recommendation algorithm 402 may aggregate the group of friends into a single entity for the purpose of producing a single restaurant recommendation 110 for the group of friends collectively. In alternate embodiments, various aggregation algorithms 402 may be used (e.g., use of Markov Random Fields (MRF), Ising model, Potts model, Gibbs distribution, Swendsen-Wang, etc.) to produce the recommendation 110.

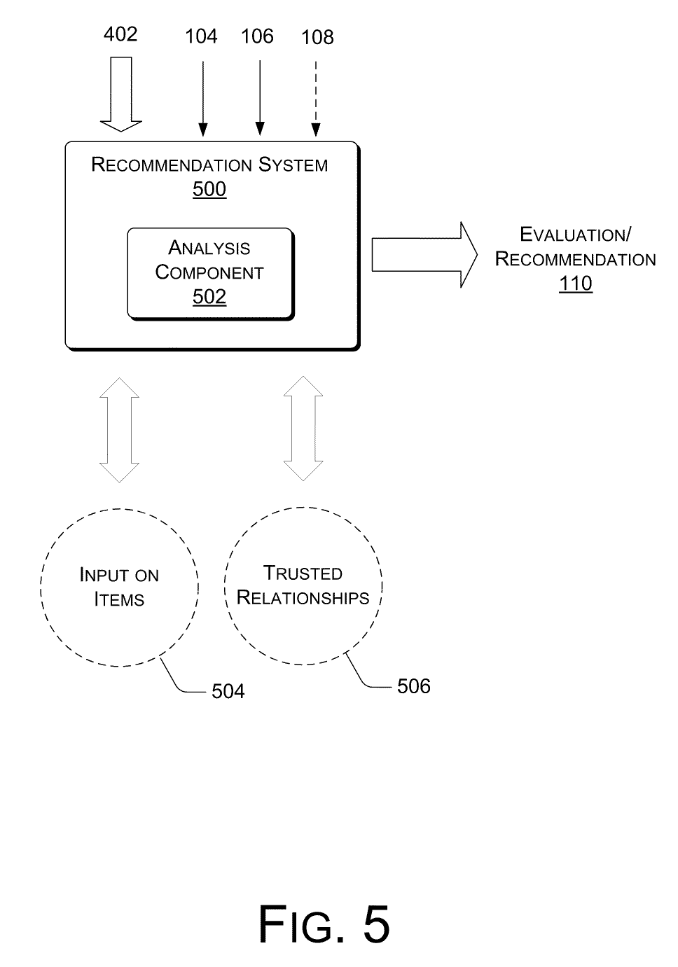

FIG. 5 illustrates a block diagram for an example recommendation system 500 that analyzes and aggregates input (e.g., votes, opinions, reviews, etc.) of users regarding an item (e.g., a product or service, etc.) using an aggregated recommendation algorithm 402. The output of the system 500 is a recommendation 110 to a group. The system 500 makes use of the group membership 104, a trusted social network 106, and optional constraints 108, to suggest a group recommendation 110 by employing an analysis component 502.

A computer implemented system may implement the aggregated recommendation algorithm 402 in an example recommendation system 500. In one embodiment, the analysis component 502 forms a collective opinion by taking input 504 of users (social network 106 members) on items, and a trusted relationship 506 established there between, outputting an evaluation and/or recommendation 110 for the item. In other embodiments, alternate or additional methods and/or inputs may be used to form the recommendation 110. For example, in one embodiment, some (or even all) of the members of the group seeking a recommendation may have prior opinions regarding the item. The system 500 may include the prior opinions/reviews of those group members when performing the analysis and aggregation to produce a group recommendation 110.

In a typical application, an item of interest (e.g., a product, service, candidate, restaurant, and the like) can exist, wherein a subset of the agents have prior opinions about such item. Any of the remaining agents can estimate whether such item is of interest and/or value, based on others' opinions. In a practical scenario, a group seeking a recommendation may consult with a person in the social network 106. This may be through a process referred to as a “Random Walk.” For example, the group (or individuals) can first consult their friends for recommendations. Likewise, such friends (if they do not have opinions of their own or have less or no experience with the item) can consult other friends. And this chain may continue until persons having opinions are found and consulted. Accordingly, based on cumulative feedback received, a collaborative opinion (e.g., subjective opinion) may be formed.

In one embodiment, an automated trust-based recommendation system 120 can simulate (or improve upon) such a process to provide high-quality personalized recommendations to agents. For example, the trust network between agents and the opinions of various agents may be captured by a directed graph, where a node on the graph represents an agent, and an edge from one node to another node represents the trust that one agent has for another agent. In one embodiment, a subset of the total network nodes may be labeled (or categorized) by indications of prior opinions. Such a partially labeled graph can be referred to as a voting network, and an algorithm that outputs a recommendation for the unlabeled nodes may be an embodiment of a recommendation system 120.

In alternate embodiments, the directed graph discussed can be a voting network while modeling a variety of two-option voting systems, including a simple star graph with voters on the outside and a final recommendation formed on the inside; a complex cyclic graph representing a social network, and the like. Other voting examples can include a voting system that includes essentially a tree with the final decision determined at the root. In other embodiments, other graphing methods may be used to model a voting system, and/or produce a group recommendation 110.

The analysis component 502 can employ one or more algorithms in order to supply the evaluation recommendation 110 regarding the item. For example, the analysis component 502 can employ an algorithm based on a personalized page rank system, random walk system, min-cut system, local, global, and iterative majority, majority of majorities, directed acyclic graph (DAG), and the like.

Further, in alternate embodiments, example axioms can be implemented with regard to the analysis component 502 (e.g., symmetry within isomorphic graphs, neutrality with regard to positive and negative votes, positive response, neighborhood consensus, transitivity, independence of irrelevant stuff (IIS), trust propagation, and the like).

Additionally, alternate embodiments may implement an artificial intelligence component in conjunction with the analysis component 502, or a support vector machine (SVM) or other classifier, including classifiers that are explicitly or implicitly trained.

Also, the recommendation system 500 can facilitate an automatic interpretation for user preference for an item (e.g., a collective behavior of users in the trust relationship, when evaluating a data.) Such preferences can then be employed as part of evaluating an item in from of a single opinion and/or recommendation that is provided for an item. By exploiting the aggregate behavior of users (e.g., not treating each user as an individual expert) the system 500 can mitigate noise, and generate relevance judgments from user behavior (e.g., feedback of users in form of votes) and in conjunction with the declared trust relationships. Examples of behavioral characteristics can include quantity of votes for different items, calculation of importance of a node/user with respect to the overall network of nodes/users, and the like. Thus, rather than expecting user(s) to adhere to a predefined set of hierarchical categories, the system allows user(s) to evaluate item(s) and based thereon, to provide a collective judgment.

### Example Graphical Analysis Methods

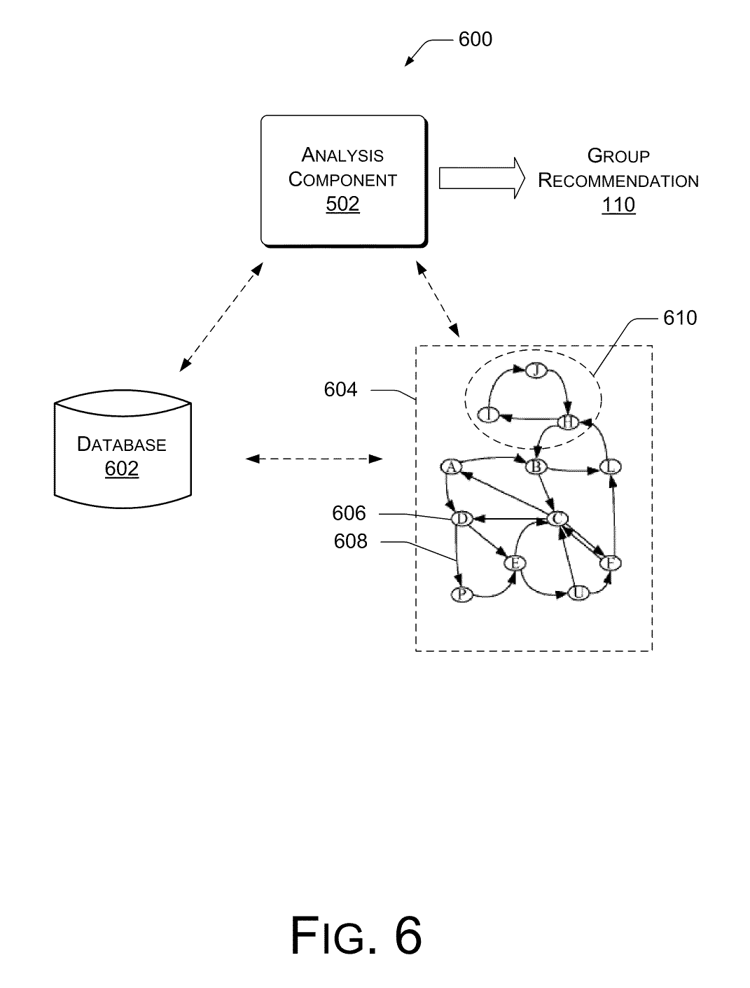

FIG. 6 illustrates a diagram of an example computer-implemented process 600, using an analysis component 502, which facilitates aggregation of input of users in a trusted social network 106. The process 600 includes a database 602 that may store mapping information and user interaction information (e.g., users declared trust relations for other users, votes regarding an item). In some embodiments, the user interaction information may be mapped to nodes 606 of the graph 604 of the social network 106. The mapping information can be continuously updated and reorganized as links within the system mapping change (e.g., users changing votes, users added or removed from the network 106, and the like).

In one embodiment, graph 604 represents a social network 106. Graph 604 may interact with the analysis component 502, wherein the social network database 602 stores information relating to social network(s). The analysis component 502 produces a collective opinion by taking input of users and trusted relationships established there between, to output an evaluation and/or recommendation 110 for an item. The analysis component 502 can supply the group a recommendation based on the trust relationships indicated by the users (e.g., which other users/nodes are trusted by this user), and the votes supplied by such other users/nodes.

Similar to previously described graphs, the graph 604 represents individuals and/or entities in a particular social network 106 as vertices (e.g., nodes 606), and relationships between two vertices are represented via an arc 608 connecting the vertices. In one embodiment, the vertices 606 can be annotated on the graph 604 with information (e.g., attributes) about the individual or entity represented by the vertex 606, in addition to declared trust relationships for other nodes. It is to be appreciated that two or more arcs 608 can be employed with respect to two vertices 606. More particularly, a unidirectional relationship between a first vertex with respect to a second vertex can be represented by a first arc, and a unidirectional relationship between the second vertex with respect to the first vertex can be represented via a second arc. Moreover, it is to be appreciated that additional arcs could be employed wherein respective arcs can represent unique subsets corresponding to relationships.

For example, referring to the graph 604 in FIG. 6, an arc points from individual (node) A to individual (node) B indicating that A is familiar with B (e.g., A considers B to be s trusted node such as a “buddy”). Accordingly, individual A is typically willing to rely on individual B in developing an opinion. Moreover, individuals B, C, and D may comprise a list or “buddy list” of individual A, implying that A has a trusted relationship with B, C, and D. Such relationship of A with respect to B, C, and D is illustrated by arcs connecting A to B, C, and D. The directionality of the arcs indicate that A contacts B and D for information and is contacted by C for information. Individuals C and F are depicted via two arcs as having a common pair of relationships, wherein each individual (C and F) considers the other a buddy or friend, and is willing to contact each other for information and is willing to provide information to each other, wherein such pair of relationships can also be referred to as a bidirectional relationship. It is to be appreciated that any of a number of suitable algorithms, programs and/or relational database schemes to effect the functionality associated with graph 604 can be employed, to supply a collective judgment, as described herein. Accordingly, within a linked structure of nodes, personalized recommendations to a group of users may be supplied about an item (or items) based upon the opinions/reviews of other users, and in conjunction with the declared trust between the users.

In one embodiment, a Markov Random Field (MRF) may be employed with the analysis component 502 to produce the group recommendation 110. For example, the MRF may make use of the graph 604 as part of the analysis. As described herein, the nodes 606 within the graph 604 may include indications as to the likely vote/opinion associated with the node 606 (e.g., the nodes may be color coded to indicate voting preference). Further, the edges may include indications representing the trust level between the nodes connected by the edge (e.g., thicker edge lines may indicate more trust).

In one embodiment, where the recommendation desired is reduced to two choices, the social network 106 may be represented as an Ising system, where each node is indicated as having a voting preference, and neighboring nodes 606 are more likely to have the same preference. In the context of the Ising model, the voting preference (opinion) of a particular site (e.g., a node or a group of neighboring nodes) within the graph may correspond to an external field at that site, based on the preference at the site.

Accordingly, using MRF, each possible indication of preference with regard to a node 606 may be assigned a probability according to the number of nearest neighbor nodes having the same intrinsic preference. In the context of the Ising model, this may be generally accomplished by showing energy distributions associated with the nodes 606. For example, a pair of nodes 606 may be shown in a graph 604, where the nodes 606 have a strong trust relationship to each other. If the nodes 606 have opposite voting preferences, then there is a high energy associated with the pair of nodes 606. Additionally, an individual energy can be associated with each of the pair of nodes 606, the individual energy based on the individual preference of each of the nodes 606. Accordingly, if this is propagated throughout the nodes 606 of the graph 604, a probability (e.g., a likely recommendation for the whole) may be assigned for the whole graph of nodes that is proportional to e^{-total energy}.

To quantify, let J_{x,y} be the amount of trust between individuals (nodes) x and y. Let H_{x,s} be the intrinsic preference of individual x for choice s. A configuration sigma records the choice sigma_x of each individual x. The weight of a configuration sigma is: exp[sum_{x,y} [1 if x and y make same choice] J_{x,y}]+sum_x H_{x,sigma x}]. The probability of a configuration is proportional to its weight.

In alternate embodiments, the described statistical mechanics methods, or the like, may be used to produce an individual recommendation (which may be aggregated as described in a two-phase approach) or a group (collective) recommendation (as in a one-phase approach). Once a probability distribution has been defined, the methods may be applied to small or large groups of nodes 606.

In the case of a small number of nodes 606, an analysis component 502 may exhaustively enumerate the different choices to determine which preferences are more probable.

In the case of a large number of nodes 606, different sampling techniques may be used for generating configurations suited to statistically determine probabilities. For example, as illustrated in FIG. 6, with a large number of nodes 606, and a small subset 610 of the nodes seeking a recommendation, the small subset may be effectively “glued together” to essentially be treated as a single node 606. Additionally, an Ising model may be generated for the entire graph 604. Thus, information on the nodes 606 that are not part of the subset 610 may be included in the recommendation. In alternate embodiments, the information on the nodes 606 that are not a part of the subset 610 may be weighted based on the information. A probability may then be computed regarding the preference (recommendation) of the “glued” node representing the subset 610 based on the model as described.

As discussed, additional tools may be used by the analysis component 502 to produce the group recommendation 110. In alternate embodiments, one or more additional tools may be combined with MRF and/or Ising modeling (Potts model, Gibbs distribution, Swendsen-Wang, etc.) to produce the group recommendation 110.

### ILLUSTRATIVE PROCESSES

FIGS. 7 and 8 illustrate methodologies for producing a group recommendation according to example embodiments. While the exemplary methods are illustrated and described herein as a series of blocks representative of various events and/or acts, the subject matter disclosed is not limited by the illustrated ordering of such blocks. For instance, some acts or events may occur in different orders and/or concurrently with other acts or events, apart from the ordering illustrated herein. In addition, not all illustrated blocks, events or acts, may be required to implement a methodology in accordance with an embodiment. Moreover, it will be appreciated that the exemplary methods and other methods according to the disclosure may be implemented in association with the methods illustrated and described herein, as well as in association with other systems and apparatus not illustrated or described.

FIG. 7 illustrates an example methodology 700 of analyzing aggregate user behavior to derive a recommendation for an item to a collective group according to an example two-phase implementation.

At block 702, each user can designate which other user(s) it trusts, wherein such trust relationships can be supplied to the analysis component (e.g., 302, 502). In one embodiment, a user can designate trust relationships by the user's membership in a social network, and/or the user's selection of friends within the social network.

At block 704, members of the social network can opine on an item, for example, participate in a voting process (e.g., casting a “yes” vote, a “no” vote,” or a “neutral” vote), and the like. The input (e.g., opinions, votes, reviews, etc.) may then be collected for analysis.

At block 706, the accumulated input may be analyzed by the analysis component, in conjunction with the already established trust relationships. At block 708, an individual recommendation may be produced based on collective evaluation and judgment of the item. Accordingly, for each given user (e.g., represented by a node in the system), other nodes (e.g., other users) that are trusted in the social network can be identified and their collective judgment employed to output a recommendation and/or evaluation for the item.

At block 710, the individual recommendations may be aggregated to produce a group recommendation. The group recommendation is output to one or more users at block 712.

FIG. 8 illustrates an example methodology 800 of analyzing aggregate user behavior to derive a recommendation for an item to a collective group according to a one-phase implementation.

At block 802, each user can designate which other user(s) it trusts, wherein such trust relationships can be supplied to the analysis component (e.g., 302, 502). In one embodiment, a user can designate trust relationships by the user's membership in a social network, and/or the user's selection of friends within the social network. In another embodiment, the user trust relationships are graphed in a graphical representation including nodes and edges.

At block 804, members of the social network can opine on an item, for example, participate in a voting process (e.g., casting a “yes” vote, a “no” vote,” or a “neutral” vote), and the like. The input may then be collected for analysis.

At block 806, the accumulated input may be analyzed by the analysis component, in conjunction with the already established trust relationships and/or graphical model(s). In alternate embodiments, statistical models and tools may be used by the analysis component (e.g., MRF, Ising model, Potts model, Gibbs distribution, Swendsen-Wang, etc.). Additionally, the accumulated input (and analysis) may be aggregated.

At block 808, a group recommendation may be produced based on the analysis and aggregation (collective evaluation and judgment of the item).

At block 810, the group recommendation is output to one or more users.

### EXEMPLARY ENVIRONMENT

All or portions of the subject matter of this disclosure can be implemented as a system, method, apparatus, or article of manufacture using standard programming and/or engineering techniques to produce software, firmware, hardware or any combination thereof to control a computer to implement the disclosure. For example, an example recommendation system may be implemented using any form of computer-readable media that is accessible by processor(s) (as shown as 914 in FIG. 9). Computer-readable media may include, for example, computer storage media and communications media.

Computer-readable storage media includes volatile and nonvolatile, removable and non-removable media implemented in any method or technology for storage of information such as computer-readable instructions, data structures, program modules or other data. Memory (as shown as 916 in FIG. 9) is an example of computer-readable storage media. Additional types of computer-readable storage media that may be present include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may accessed by the processor(s).

In contrast, communication media typically embodies computer readable instructions, data structures, program modules, or other data in a modulated data signal, such as a carrier wave, or other transport mechanism.

In order to provide a context for the various aspects of the disclosed subject matter, FIGS. 9 and 10 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the subject matter also may be implemented in combination with other program modules. Generally, program modules include routines, programs, components, data structures, and the like, which perform particular tasks and/or implement particular abstract data types.

Moreover, those skilled in the art will appreciate that the innovative methods can be practiced with other computer system configurations, including single-processor or multiprocessor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the disclosure can be practiced on stand-alone computers. In a distributed computing environment, program modules may be located in both local and remote memory storage devices.

With reference to FIG. 9, an exemplary environment 910 for implementing various aspects of the subject disclosure is described that includes a computer 912. The computer 912 includes a processing unit 914, a system memory 916, and a system bus 918. The system bus 918 couples system components including, but not limited to, the system memory 916 to the processing unit 914. The processing unit 914 can be any of various available processors. Dual microprocessors and other multiprocessor architectures also can be employed as the processing unit 914.

The system bus 918 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 916 includes volatile memory 920 and nonvolatile memory 922. The basic input/output system (BIOS), containing the basic routines to transfer information between elements within the computer 912, such as during start-up, is stored in nonvolatile memory 922. For example, nonvolatile memory 922 can include read only memory (ROM), programmable ROM (PROM), electrically programmable ROM (EPROM), electrically erasable ROM (EEPROM), or flash memory. Volatile memory 920 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), and the like.

Computer 912 also includes removable/non-removable, volatile/non-volatile computer storage media. FIG. 9 illustrates a disk storage 924, wherein such disk storage 924 includes, but is not limited to, devices like a magnetic disk drive, floppy disk drive, tape drive, Jaz drive, Zip drive, LS-60 drive, flash memory card, or memory stick. In addition, disk storage 924 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 924 to the system bus 918, a removable or non-removable interface is typically used such as interface 926.

It is to be appreciated that FIG. 9 describes software that acts as an intermediary between users and the basic computer resources described in suitable operating environment 910. Such software includes an operating system 928. Operating system 928, which can be stored on disk storage 924, acts to control and allocate resources of the computer system 912. System applications 930 take advantage of the management of resources by operating system 928 through program modules 932 and program data 934 stored either in system memory 916 or on disk storage 924. It is to be appreciated that various components described herein can be implemented with various operating systems or combinations of operating systems.

In alternative embodiments, a user may enter commands or information into the computer 912 through input device(s) 936. Input devices 936 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 914 through the system bus 918 via interface port(s) 938. Interface port(s) 938 include, for example, a serial port, a parallel port, a game port, and a universal serial bus (USB). Output device(s) 940 use some of the same type of ports as input device(s) 936. Thus, for example, a USB port may be used to provide input to computer 912, and to output information from computer 912 to an output device 940. Output adapter 942 is provided to illustrate that there are some output devices 940 like monitors, speakers, and printers, among other output devices 940 that require special adapters. The output adapters 942 include, by way of illustration and not limitation, video and sound cards that provide a means of connection between the output device 940 and the system bus 918. It should be noted that other devices and/or systems of devices provide both input and output capabilities such as remote computer(s) 944.

Computer 912 can operate in a networked environment using logical connections to one or more remote computers, such as remote computer(s) 944. The remote computer(s) 944 can be a personal computer, a server, a router, a network PC, a workstation, a microprocessor based appliance, a peer device or other common network node and the like, and typically includes many or all of the elements described relative to computer 912. For purposes of brevity, only a memory storage device 946 is illustrated with remote computer(s) 944. Remote computer(s) 944 is logically connected to computer 912 through a network interface 948 and then physically connected via communication connection 950. Network interface 948 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 950 refers to the hardware/software employed to connect the network interface 948 to the bus 918. While communication connection 950 is shown for illustrative clarity inside computer 912, it can also be external to computer 912. The hardware/software necessary for connection to the network interface 948 includes, for exemplary purposes only, internal and external technologies such as, modems including regular telephone grade modems, cable modems and DSL modems, ISDN adapters, and Ethernet cards.

FIG. 10 is a schematic block diagram of a sample-computing environment 1000 that can be employed for the recommendation system, in accordance with an aspect of the subject disclosure. The system 1000 includes one or more client(s) 1010. The client(s) 1010 can be hardware and/or software (e.g., threads, processes, computing devices). The system 1000 also includes one or more server(s) 1030. The server(s) 1030 can also be hardware and/or software (e.g., threads, processes, computing devices). The servers 1030 can house threads to perform transformations by employing the components described herein, for example. One possible communication between a client 1010 and a server 1030 may be in the form of a data packet adapted to be transmitted between two or more computer processes. The system 1000 includes a communication framework 1050 that can be employed to facilitate communications between the client(s) 1010 and the server(s) 1030. The client(s) 1010 are operatively connected to one or more client data store(s) 1060 that can be employed to store information local to the client(s) 1010. Similarly, the server(s) 1030 are operatively connected to one or more server data store(s) 1040 that can be employed to store information local to the servers 1030.

### CONCLUSION

Although implementations of a recommendation system have been described in language specific to structural features and/or methodological acts, it is to be understood that the subject matter defined in the appended claims is not necessarily limited to the specific features or acts described above. Rather, the specific features and acts are disclosed as illustrative forms of illustrative implementations of controlling access to resources. For example, the methodological acts need not be performed in the order or combinations described herein, and may be performed in any combination of one or more acts.

1. A system for providing a group recommendation to a group of users collectively, the group of users comprising a subset of a social network, the system comprising:
a processor;
memory coupled to the processor;
an analysis component stored in the memory and operable on the processor to produce a plurality of individual recommendations for an item, based on trust relationships between members of the group of users and members of the social network that are not members of the group of users; and
an aggregation component stored in the memory and operable on the processor to aggregate the plurality of individual recommendations to produce the group recommendation.

2. The system of claim 1, wherein the members of the social network are represented in a graph as nodes and the trust relationships are represented in the graph as edges between the nodes.

3. The system of claim 2, wherein the graph is a Directed Acyclic Graph (DAG).

4. The system of claim 1, wherein the analysis component is configured to produce the plurality of individual recommendations based on voting behavior of the members of the social network.

5. The system of claim 1, wherein the analysis component is configured to produce the plurality of individual recommendations based on a statistical system of Majority-of-Majorities (MOM).

6. The system of claim 1, wherein the analysis component is configured to produce the plurality of individual recommendations based on a Random Walk System (RW).

7. The system of claim 1, wherein the analysis component is configured to produce the plurality of individual recommendations based on a Min-cut system (mincut).

8. One or more computer readable media comprising computer executable instructions that, when executed by a computer processor, direct the computer processor to provide a recommendation to a group of users collectively, the group of users comprising a subset of a social network, the providing comprising:
designating trust relationships between members of the social network;
collecting input from members of the social network regarding an item;
analyzing, by a computer processor, the input in conjunction with the designated trust relationships;
producing, by the computer processor, individual recommendations based on the analyzing;
aggregating, by the computer processor, the individual recommendations to produce an aggregated recommendation; and
outputting the aggregated recommendation to the group.

9. The one or more computer readable media of claim 8, wherein the designating comprises representing the members of the social network as graph nodes and representing the trust relationships as graph edges.

10. The one or more computer readable media of claim 9, wherein the graph is a Directed Acyclic Graph (DAG).

11. The one or more computer readable media of claim 9, wherein the designating comprises assigning weights to the edges based on the trust relationships.

12. The one or more computer readable media of claim 9, wherein the graph is undirected such that relations between nodes are symmetric.

13. The one or more computer readable media of claim 8, wherein the input is collected only from members of the social network not in the group.

14. A computer implemented method of providing a recommendation to a group of users collectively, the group of users comprising a subset of a social network, the method comprising:
designating trust relationships between members of the social network;
collecting input from members of the social network regarding an item;
analyzing, by a computer processor, the input in conjunction with the designated trust relationships;
aggregating, by the computer processor, the input based on the analyzing and an aggregation algorithm;
producing, by the computer processor, a group recommendation based on the analyzing and the aggregating; and
outputting the group recommendation to the subset.

15. The method of claim 14, wherein at least one of the analyzing, aggregating, and producing further comprises using a Markov Random Field (MRF), where a graph of the MRF represents the trust relationships between the members of the social network.

16. The method of claim 14, wherein the designating comprises representing the members of the social network as graph nodes and representing the trust relationships as graph edges.

17. The method of claim 16, wherein the graph is a Directed Acyclic Graph (DAG).

18. The method of claim 16, wherein the designating comprises assigning weights to the edges and/or the nodes based on the trust relationships.

19. The method of claim 14, further comprising evaluating the structure of the social network;
wherein the analyzing and/or aggregating are based on the evaluating.

20. The method of claim 14, further comprising representing the social network as an Ising system.
